(19) United States
(12) Patent Application Publication
(10) Pub. No.: US 2011/0292349 A1
(43) Pub. Date: Dec. 1, 2011

(54) LIGHT SOURCE DEVICE, LIGHTING DEVICE AND IMAGE DISPLAY DEVICE USING SUCH LIGHT DEVICE

(75) Inventors: Hiroshi Kitano, Hyogo (JP); Yoshimasa Fushimi, Osaka (JP); Shigekazu Yamagishi, Osaka (JP); Takaaki Tanaka, Osaka (JP)

(73) Assignee: Panasonic Corporation, Osaka (JP)

(21) Appl. No.: 13/117,145

(22) Filed: May 27, 2011

(30) Foreign Application Priority Data
May 27, 2010 (JP) 2010-121092

(51) Int. Cl. G03B 21/14; F21V 9/16; F21V 9/00

(52) U.S. Cl. 353/31; 362/231; 362/84

(57) ABSTRACT

For a lighting device for obtaining output light in the wavelengths of light of three colors of red, green, and blue, a lighting device using a semiconductor laser for the blue light has been proposed. When using this lighting device in an image display device, etc., there are problems in blue color rendering properties and reduced image quality due to speckle noise. A light source device designed to emit red light, green light, a first blue light, and a second blue light, the light source device including: a red solid-state light source; a green solid-state light source; a semiconductor laser for emitting the first blue light; and a blue light generation part for emitting the second blue light, wherein the main component of the second blue light is light in a wavelength range of wavelengths longer than that of the first blue light.

### CROSS REFERENCE TO RELATED APPLICATION

The disclosure of Japanese Patent Application No. 2010-121092, filed on May 27, 2010, is incorporated herein by reference.

### BACKGROUND OF THE INVENTION

1. Field of the Invention

The present invention relates to light source devices using a blue laser, and in particular, to light source devices, utilized in lighting devices, that combine red, green, and blue light and emit the combined light for use in an image display device.

2. Description of the Background Art

Projectors as image display devices for the magnified projection of various video and other images on a screen have become popular today. In such projectors, light emitted from a light source is condensed on a spatial light modulator such as a digital micromirror device (DMD) or a liquid-crystal-display element, and light modulated by video signals and emitted from the spatial light modulator is displayed as a color video image on the screen.

In order to obtain a bright, large-screen-sized video image from a projector, high brightness discharge lamps have been conventionally used as a light source. However, in a case where lamps are used as a light source, there are problems in that: the life of the light source is short, which results in cumbersome maintenance; the optical system tends to be complicated since white light composed of a continuous spectrum is split into three primary colors of red, green, and blue; and the color reproduction range is narrow.

In order to solve these problems, a lighting device using a solid-state light source such as light emitting diodes (LED) or lasers instead of the discharge lamps, and a new image display device using the lighting device has been proposed (Japanese Laid-open Patent Publication No. H10-293545).

Since an LED light source has a longer life than a discharge lamp, and since its emission spectral width is relatively narrow, it is possible to secure a wide color reproduction range. However, there is a problem in that since the light emission brightness is low per unit area in a light emitting part, it is difficult to obtain a bright lighting device.

Meanwhile, a laser light source has a problem in that speckle noise occurs due to high interference, which results in a deteriorated image quality. However, with a laser light source having a longer life than a discharge lamp, a wide color reproduction range can be secured due to its monochromaticity, and in addition, laser light has a high light density and a high directivity. Therefore, it is possible to configure a bright lighting device.

An example of a small, high efficient, and practical laser light source is a semiconductor laser. Semiconductor lasers having the red and blue wavelength ranges have already been put to practical use. On the other hand, with respect to the green wavelength range, high output semiconductor lasers have not been put to practical use to date. In order to obtain green illumination light by using a laser light source, a method using second harmonics of infrared laser light is used in general.

Semiconductor lasers having the blue wavelength range that have been put to practical use at present are GaN-based semiconductor lasers. GaN-based semiconductor lasers are very popular as optical-disk purple lasers having an oscillation wavelength of about 405 nm. However, these lasers have a characteristic that when the oscillation wavelength becomes long, the light emission efficiency is reduced, resulting in difficulty in obtaining high output light. On the contrary, when the wavelength becomes short from blue to purple, the light emission efficiency is improved. However, the visibility by human eyes is reduced, and moreover, during high output operation, reliability of the lasers is reduced, which are problems of these lasers. Therefore, in a case where blue light is outputted by using a GaN semiconductor laser, it is appropriate to select the oscillation wavelength of 440 to 450 nm. If the oscillation wavelength is longer or shorter than this, it is difficult to attain high output and high reliability at the same time.

However, in the case of a lighting device that outputs white light by combining light of three colors, that is, red, green, and blue, when a blue laser light whose oscillation wavelength is 440 to 450 nm is used, there is a problem in its color rendering properties. FIG. 12 shows, by using the xy-chromaticity diagram by International Commission on Illumination (CIE), the color reproduction range of a lighting device using laser beams whose oscillation wavelengths are 445 nm, 532 nm, and 640 nm, respectively, and the color gamut according to sRGB standard, which is a color space international standard defined by International Electrotechnical Commission (IEC). A triangle 101 shown in solid lines is the color reproduction range of the lighting device obtained by using the laser beams of three colors, and a triangle 102 shown by dotted lines is the color reproduction range according to the sRGB standard.

The sRGB standard is a color standard most commonly used in various display apparatuses. In a case where a lighting device is applied to an image display device such as a projector, the color reproduction range of the lighting device desirably encompasses the color gamut according to the sRGB standard.

However, as shown in FIG. 12, in a case where a blue semiconductor laser is used as the blue light source, since its wavelength is short, the blue xy-chromaticity coordinates have large x-coordinate values and small y-coordinate values, and thus cannot completely encompass the sRGB color gamut. As specific color rendering properties, monochromatic light whose wavelength is 450 nm or less has very purplish tone and proves a little unnatural as blue light.

The present invention is made in view of the above circumstances, and an object of the present invention is to provide a light source device that allows high efficiency illumination light utilizing the characteristics of laser light to be obtained, that improves the blue color rendering properties, and that further allows a lighting device having reduced speckle noise to be obtained.

### SUMMARY OF THE INVENTION

A light source device according to the present invention is directed to a light source device designed to emit red light, green light, and blue light, the blue light including first blue light and second blue light, the light source device comprising: a red solid-state light source for emitting the red light; a green solid-state light source for emitting the green light; a semiconductor laser for emitting the first blue light; and a blue light generation part for emitting the second blue light, wherein the main component of the second blue light is light in a wavelength range of wavelengths longer than that of the first blue light.

According to this configuration, as a light source device that can be used in a lighting device that outputs white light by combining light of three colors, that is, red output light, green output light, and blue output light, in a case where the wavelength of the light from the semiconductor laser, which is a light source of the first blue light, is short, the light source device can add an auxiliary second blue light having a wavelength longer than that of the blue laser light, and can generate blue output light by mixing these kinds of blue light.

In particular, the dominant wavelength of the first blue light is greater than or equal to 435 nm and less than or equal to 455 nm, and the dominant wavelength of the second blue light is greater than or equal to 455 nm and less than or equal to 510 nm. Moreover, the dominant wavelength of the blue output light obtained by combining the first blue light and the second blue light is greater than or equal to 455 nm and less than or equal to 475 nm.

For example, the practical laser emission wavelength when obtaining high output blue light by using a GaN-based blue semiconductor laser is in a range greater than or equal to 435 nm and less than or equal to 455 nm, and if the dominant wavelength of the first blue light is in this wavelength range, the present invention is especially preferable. In that case, as the second blue light, light whose dominant wavelength is greater than or equal to 455 nm and less than or equal to 510 nm is preferable.

With respect to the blue output light obtained by mixing the first and the second blue light, it is preferable that the light spectrum and the intensity ratio of the first and the second blue light are adjusted such that the dominant wavelength of the blue output light becomes greater than or equal to 455 nm and less than or equal to 475 nm. Such an intensity ratio can improve the purplish chromaticity of the first blue light. It is especially preferable that the light spectrum and the intensity ratio of the first and the second blue light are adjusted such that the dominant wavelength of the blue output light becomes greater than or equal to 460 nm and less than or equal to 470 nm. By adjusting the chromaticity to realize dominant wavelengths of this sort, it is possible to obtain blue output light that is superior in color rendering properties and that can encompass the sRGB standard range.

Further, in the light source device according to the present invention, the light source of the second blue light is a solid-state light source such as a light emitting diode or a fluorescent material; the second blue light is composed of light emitted from a fluorescent material that uses the light source of the first blue light as an excitation light source; and the green light source for obtaining the green output light is composed of a solid-state light source, which is one of a light emitting diode and a fluorescent material.

The present invention is a light source device using a semiconductor laser, being a solid-state light source, as first, primary blue light. In configuring a light source device using the advantageous point thereof, as light sources for obtaining second blue light and green light, it is preferable to use light emitting diodes or fluorescent materials, which are solid-state light sources.

Further, in the light source device according to the present invention, the second blue light can be obtained by separating a part of light from the green light source by means of a color separation member such as a dichroic mirror or the like, and the dominant wavelength of the green output light is longer than the dominant wavelength of the second blue light.

As the green light source, a light emitting diode or a fluorescent material can be used. Such a light source is a light source having an appropriate spectrum range having its peak in the green wavelength range. Therefore, it is possible to separate, from among emission spectrum components thereof, short-wavelength components by a dichroic mirror, to be used as second blue light.

Further, in the light source device according to the present invention, it is also possible to cause the first blue light and the second blue light to be emitted at staggered timings. According to this configuration, it is possible to obtain, as blue output light, light that is obtained by time-averaging the two kinds of blue light.

Moreover, the light source device according to the present invention further includes an illuminance uniformizing part which combines red light, green light, and a first blue light, and a second blue light emitted from the light source device, and uniformizes the illuminance. The illuminance uniformizing part is a rod integrator or a lens array.

It is possible to configure a lighting device by using the above lighting device and a relay optical system.

It is possible to configure an image display device by using the above lighting device, a spatial light modulator, and a projection optical system which projects on a screen an image emitted from the spatial light modulator.

According to the present invention, by using a solid-state light source which has a long life and does not require mercury, it is possible to realize a light source device that can be used in a lighting device superior in color rendering properties and having appropriate red, green, and blue chromaticity. Moreover, it is possible to provide a lighting device and an image display device using the light source device.

### BRIEF DESCRIPTION OF THE DRAWINGS

FIG. 1 is a diagram showing a configuration of a light source device, and a lighting device and an image display device using the light source device according to a first embodiment;

FIG. 2 is a diagram illustrating a spectrum of output light from the light source device according to the first embodiment;

FIG. 3 is a diagram showing a configuration of a light source device and an image display device using the light source according to a second embodiment;

FIG. 4 is a diagram illustrating a spectrum of output light from the light source device according to the second embodiment;

FIG. 5 is a diagram showing a configuration of a light source device, and a lighting device and an image display device using the light source device according to a third embodiment;

FIG. 6 is a diagram illustrating a spectrum of output light from the light source device according to the third embodiment;

FIG. 7 is a diagram showing a configuration of a light source device, and a lighting device and an image display device using the light source device according to a fourth embodiment;

FIG. 8 is a diagram illustrating a segment configuration of a glass base material of the light source device according to the fourth embodiment;

FIG. 9 is a diagram illustrating a spectrum of output light from the light source device according to the fourth embodiment;

FIG. 10 is a diagram showing a configuration of a light source device and a lighting device using the light source device according to a fifth embodiment;

FIG. 11 is a diagram illustrating a segment configuration of a glass base material of the light source device according to the fifth embodiment; and

FIG. 12 is a diagram illustrating color reproduction ranges of an image display device using a laser and of a sRGB standard.

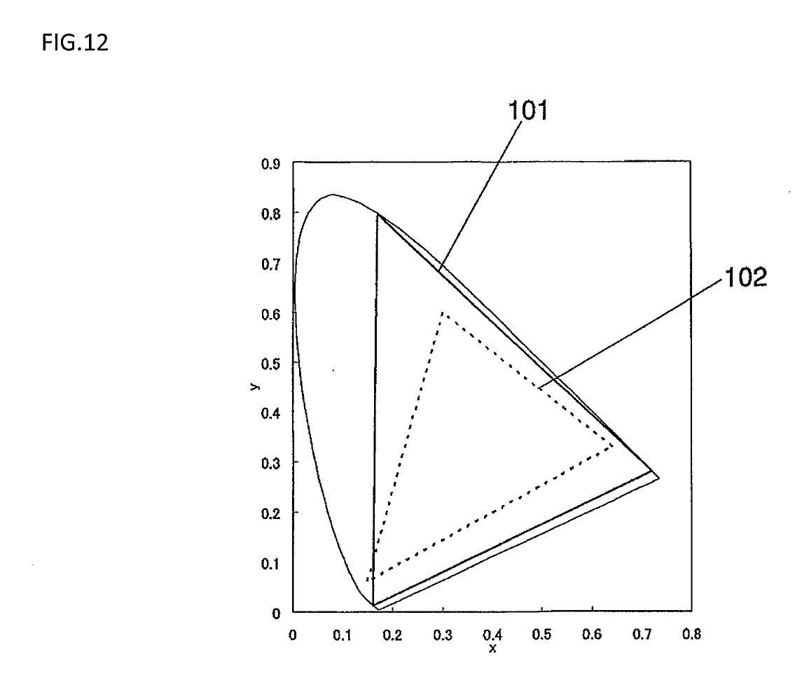

### DESCRIPTION OF THE PREFERRED EMBODIMENTS

Hereinafter, embodiments of a light source device, and a lighting device and an image display device using the light source device according to the present invention will be described with reference to the drawings.

### Embodiment 1

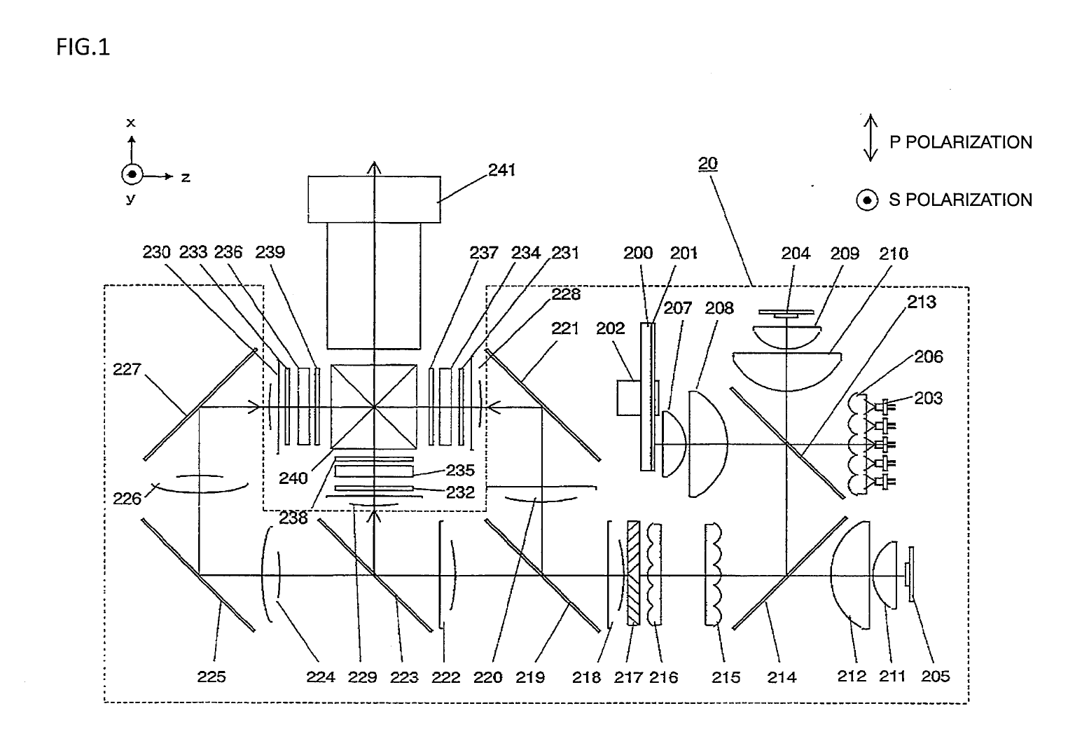

FIG. 1 shows a configuration of a light source device, and a lighting device and an image display device using the light source device according to a first embodiment. The image display device includes a lighting device 20 and other optical elements and the like that constitute the image display device.

A dichroic coat that efficiently reflects visible light is applied to the surface of one side of a glass base material 200, and further, a fluorescent material 201 which emits green fluorescence is applied on that thin film. Although the method of making the thin film of the fluorescent material is not particularly limited, examples of such method include the precipitation method, and the printing method. As shown in FIG. 1, the glass base material 200 is rotatable, in an xyz-coordinate system, about the z axis by means of a rotation part 202.

An excitation light source 203 is a blue semiconductor laser that oscillates around the wavelength of about 445 nm, and is composed of a plurality of laser diodes in order to realize a high brightness light source device. In the present embodiment, a total of 25 laser diodes are arranged in a 5×5 matrix. However, the number is not limited thereto, and is set as appropriate in accordance with the intensity the fluorescence that is desired to be obtained. As shown in FIG. 1, all of the laser diodes are adjusted so as to realize P polarization.

Excitation light emitted from the excitation light source 203 is collimated by a collimator lens array 206. One laser diode is provided for each lens cell of the collimator lens array 206. After passing through a dichroic mirror 213, the collimated laser light is condensed on the fluorescent material 201 by condenser lenses 207 and 208. The collimator lens array 206 and the condenser lenses 207 and 208 are adjusted such that all beams emitted from the plurality of laser diodes form a spot having a certain diameter or less on the fluorescent material 201. In the present embodiment, the spot diameter is adjusted to about ø3 mm. Here, the condenser lenses are composed of a set of two lenses. However, the condenser lens may be composed of one lens or three or more lenses.

The fluorescent material 201 is applied to all over the circular surface of the glass base material 200 such that even when the glass base material 200 is rotated about the z axis, the excitation light is always radiated onto the fluorescent material. Green fluorescence emitted in the +z direction from the fluorescent material 201 is substantially collimated by the condenser lenses 207 and 208 and reflected by the dichroic mirror 213.

Not all of the excitation light is wavelength-converted into green fluorescence at the fluorescent material 201, but there exists unconverted blue light. Of the blue excitation light incident on the fluorescent material 201, the unconverted blue light passes through the condenser lenses 207 and 208 again to be substantially collimated. The unconverted blue light is scattered light scattered by the fluorescent material 201, and there exists light having polarization direction different from that at the time when the light was incident on the fluorescent material. Therefore, among components of the unconverted blue light that are incident on the dichroic mirror 213 again, S polarization components are reflected by the dichroic mirror 213, which components will be first blue light.

A blue light source 204 is an LED light source that is designed to emit light whose main components are in a wavelength range of wavelengths longer than those of the blue light from the excitation light source 203 and of wavelengths shorter than those of the green fluorescence from the fluorescent material 201. In the present embodiment, an LED whose dominant wavelength is 462 nm is used. The blue light emitted from the blue light source 204 is collimated by collimator lenses 209 and 210, and then passes through the dichroic mirror 213. This resulting light will be second blue light. That is, in the present embodiment, the first blue light is obtained from the excitation light source 203, which is a blue semiconductor laser, and the second blue light is obtained, by the blue LED (the blue light source 204), which is a solid-state light source, functioning as a blue light generation part.

The dichroic mirror 213 is a dichroic mirror having a high transmission characteristic for P polarized light and a high reflection characteristic for S polarized light, in the wavelength range of the excitation light source 203; and a high reflection characteristic, irrespective of the type of polarization, that is, the P polarization or S polarization, in the dominant wavelength range of the light from the blue light source 204 and in the dominant wavelength range of the fluorescence from the fluorescent material 201.

Although not shown, it is also possible to configure an optical system essentially equivalent to that according to the present embodiment in the following manner: the characteristics of the dichroic mirror used in the present embodiment may be reversed, and a dichroic mirror may be used that has a high transmission characteristic for the light from the blue light source 204 and the green fluorescence from the fluorescent material 201, and the excitation light source may be arranged so as to allow the S polarization.

A red light source 205 is a red LED whose dominant wavelength is 623 nm, and the light emitted therefrom is collimated by collimator lenses 211 and 212.

The green fluorescence and the first and the second blue light are reflected by a dichroic mirror 214. On the other hand, the red light from the red light source 205 passes through the dichroic mirror 214.

The above-described kinds of light are spatially combined and the resultant light passes through a first integrator lens array 215, a second integrator lens array 216, a polarization conversion element 217, and a condenser lens 218, which constitute an illuminance uniformizing part, and then is spatially split according to wavelengths. In the present embodiment, the light source device which emits red light, green light, the first blue light, and the second blue light is structured in the above configuration.

Next, components constituting a relay optical system will be described. A dichroic mirror 219 is a dichroic mirror having characteristics of reflecting the first and the second blue light and transmitting green light and red light. The blue light reflected by the dichroic mirror 219 advances to a relay lens 220 and a reflection mirror 221, and then is emitted as blue output light to the outside of the lighting device 20.

Of the light that has passed through the dichroic mirror 219 and a relay lens 222, green fluorescence is reflected by a dichroic mirror 223, to be emitted as green output light to the outside of the lighting device 20. The red light which has passed through the dichroic mirror 223 advances to relay lenses 224 and 226 and reflection mirrors 225 and 227, and then emitted as red output light to the outside of the lighting device 20.

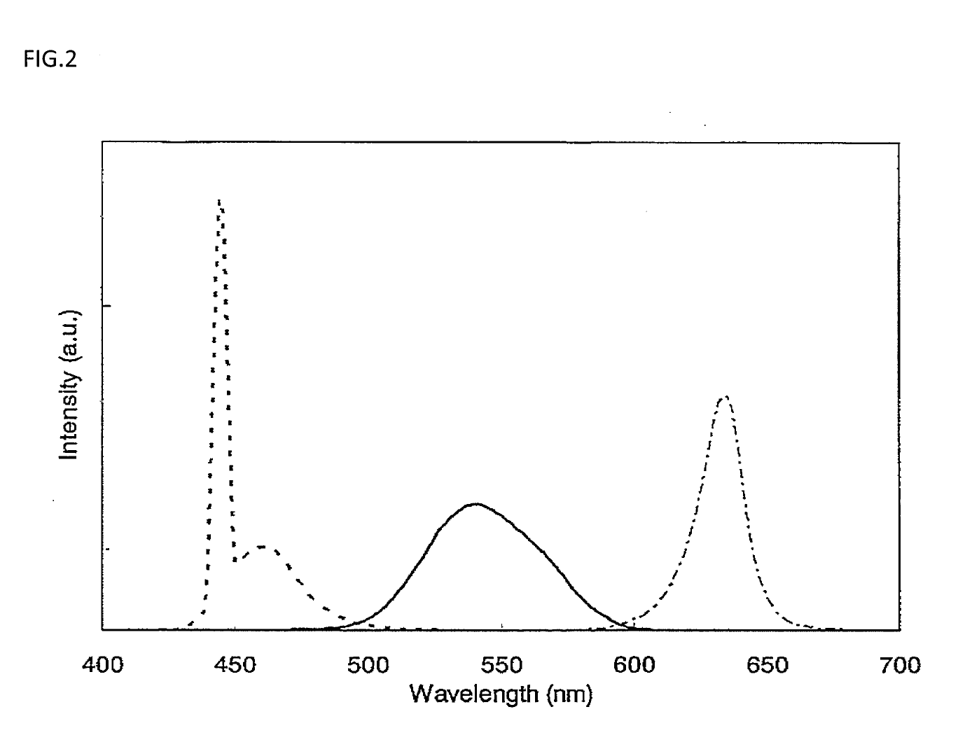

FIG. 2 shows the light spectra of the red output light, the green output light, and the blue output light, which are the output light of three colors from the lighting device 20.

The spectra of the red output light and the green output light have shapes reflecting the emission spectra of the red LED and the green fluorescent material, respectively.

The spectrum of the blue output light has a shape having two peaks as shown in FIG. 2. The short-wavelength components having a peak around 445 nm represents the spectrum of the first blue light, and the long-wavelength components having a peak around 462 nm represents the spectrum of the second blue light. The sum of the first blue light and the second blue light constitutes the blue output light. The xy-chromaticity coordinates of the first blue light are: x=0.161 and y=0.014, and the xy-chromaticity coordinates of the second blue light are: x=0.139 and y=0.053. The xy-chromaticity coordinates of the blue output light obtained by mixing them are: x=0.151 and y=0.031, and the blue color rendering properties have been improved.

The illumination light of three colors outputted from the lighting device 20 pass through field lenses 228, 229, and 230 and incident-side polarizing plates 231, 232, and 233, and then are incident on a blue liquid-crystal-display element 234, a green liquid-crystal-display element 235, and a red liquid-crystal-display element 236, respectively.

Signal lights modulated in accordance with input video signals by these liquid-crystal-display elements pass exit-side polarizing plates 237, 238, and 239, and then are incident on a cross dichroic prism 240. The modulated signal light of three colors, that is red, green, and blue, are spatially combined by the cross dichroic prism 240, to be projected on a screen (not shown) in a magnified manner by a projector lens 241.

### Embodiment 2

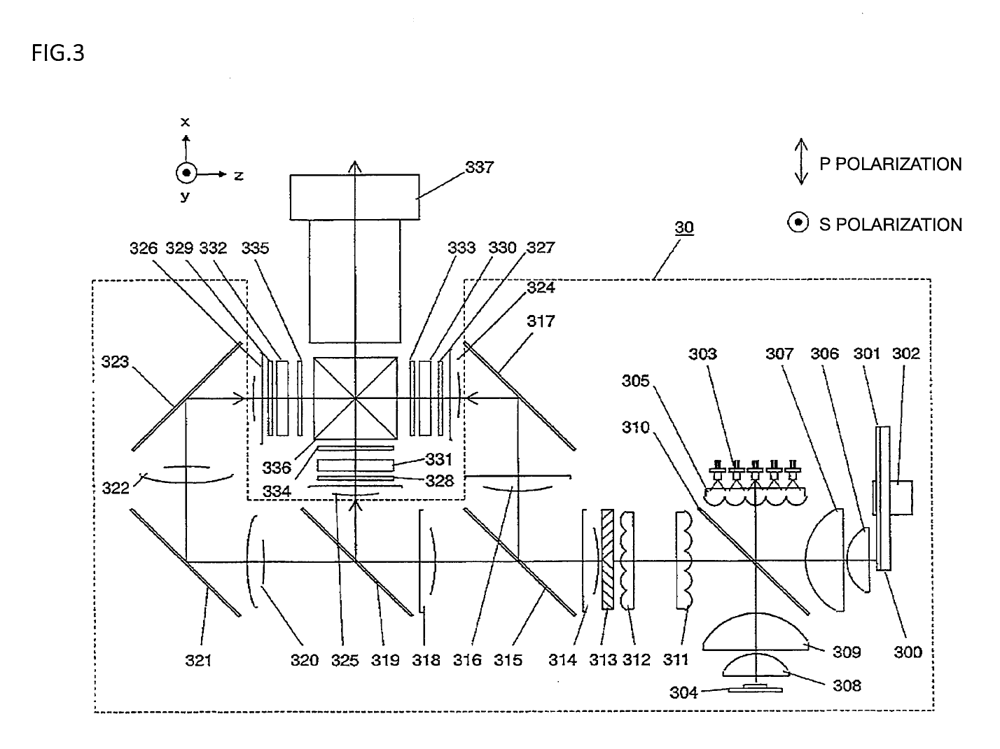

FIG. 3 shows a configuration of a light source device, and a lighting device and an image display device using the light source device according to a second embodiment. The image display device according to the present embodiment is equivalent to that in embodiment 1, except for the characteristics of a dichroic mirror 315 located after a first integrator lens array 311. Therefore, description of the same configurations will be omitted.

The difference between the light source used in embodiment 2 and that in embodiment 1 is whether a blue LED is used. The present embodiment does not use a blue LED.

An excitation light source 303 is a blue semiconductor laser that oscillates around the wavelength of about 445 nm, and all of the laser diodes are adjusted so as to realize S polarization. Excitation light emitted from the excitation light source 303 is collimated by a collimator lens array 305, reflected by a dichroic mirror 310, and then condensed by condenser lenses 306 and 307 onto a fluorescent material 301 which emits green fluorescence. The dichroic mirror 310 is a dichroic mirror having characteristics that it transmits green fluorescence in a highly efficient manner, and reflects light in the red light wavelength range in a highly efficient manner. The dichroic mirror 310 has characteristics that, in the wavelength range of the excitation light, it exhibits a high transmission characteristic for P polarized light, and exhibits a high reflection characteristic for S polarized light.

The fluorescent material 301 is applied to all over the circular surface of a glass base material 300, and the glass base material 300 rotates about the z axis. Green fluorescence emitted in the −z direction from the fluorescent material 301 is collimated by the condenser lenses 306 and 307, and passes through the dichroic mirror 310. Of the blue excitation light incident on the fluorescent material 301, P polarization components of unconverted blue light pass through the condenser lenses 306 and 307 to be collimated, and then pass through the dichroic mirror 310.

A red light source 304 is a red LED whose dominant wavelength is 623 nm, and the light emitted therefrom is collimated by collimator lenses 308 and 309, and then reflected by the dichroic mirror 310.

Light obtained by the dichroic mirror 310 spatially combining the unconverted excitation light, the green fluorescence, and the red LED light passes through an integrator lens array 311 and the like which constitute an illuminance uniformizing part, and then spatially split by the dichroic mirror 315 again.

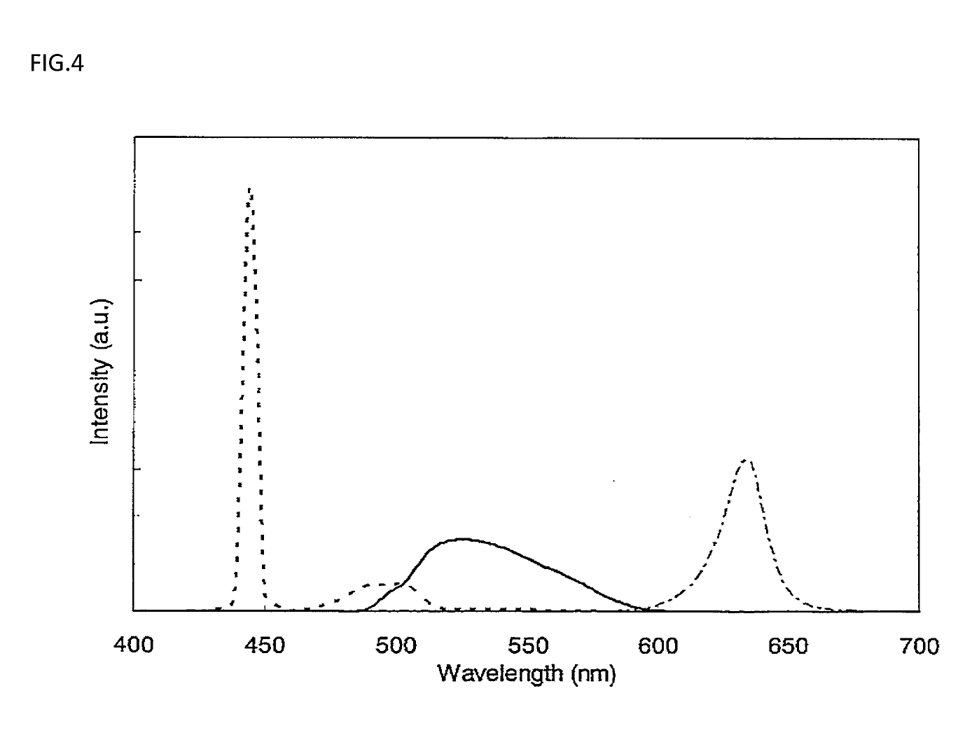

FIG. 4 shows spectra of the light of three colors outputted from a lighting device 30 to be incident on red, blue, green liquid-crystal-display elements. In the present embodiment, as the green fluorescent material, a fluorescent material is used that emits light having more short-wavelength components than the fluorescent material used in embodiment 1.

By selecting the cutoff wavelength of the dichroic mirror 315 of about 505 nm, short-wavelength components of the fluorescence are reflected by the dichroic mirror. Therefore, the reflected light components can be used as the second blue light. That is, in the present embodiment, the first blue light is obtained as blue excitation light that has been emitted from the excitation light source 303, which is a blue semiconductor laser, and that has not been converted by the fluorescent material 301; and the second blue light is obtained from the short-wavelength components of the green fluorescence obtained from the fluorescent material 301 which is a solid-state light source, the short-wavelength components being reflected by the dichroic mirror 315 functioning as a color separation member (blue color generation part).

The dominant wavelength of the unconverted excitation light, which is the first blue light, is 445 nm, and the xy-chromaticity coordinates thereof are x=0.161 and y=0.014. The dominant wavelength of the second blue light, which is composed of a part of spectral components of the fluorescence, is 487 nm, and the xy-chromaticity coordinates thereof are x=0.098 and y=0.414. The xy-chromaticity coordinates of the blue output light obtained by mixing these two kinds of light are x=0.153 and y=0.064. The xy-chromaticity coordinates of the red output light are x=0.699 and y=0.301, and the xy-chromaticity coordinates of the green output light are x=0.252 and y=0.694. That is, light of three colors outputted from the lighting device according to the present embodiment are illumination light that has superior color rendering properties having a color reproduction range that encompasses substantially all of the sRGB standard range.

### Embodiment 3

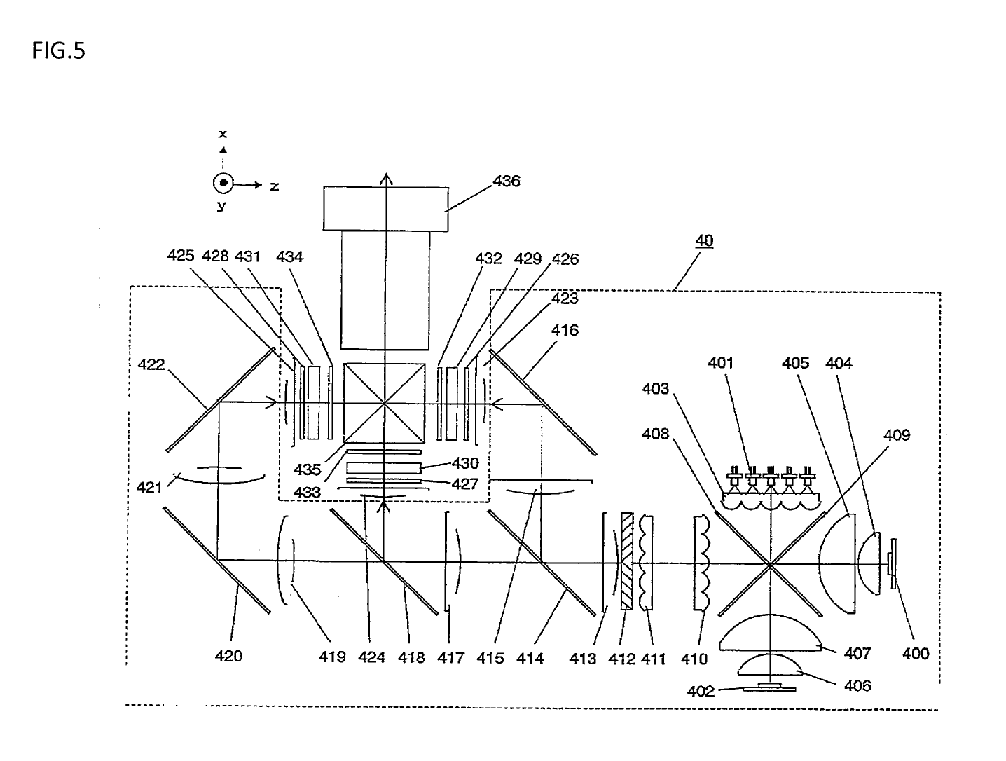

FIG. 5 shows a configuration of a light source device, and a lighting device and an image display device using the lighting device according to a third embodiment. The image display device according to the present embodiment is equivalent to that in embodiment 1, except for the characteristics of a dichroic mirror 414 located after a first integrator lens array 410.

In the present embodiment, a green LED is used as a green light source 400, instead of the green fluorescent material. A red light source 402 is a red LED, and an excitation light source 401 of the first blue light is a blue semiconductor laser that oscillates around the wavelength of about 445 nm. Similarly to embodiment 1, the light of three colors are collimated by collimator lenses, spatially combined by dichroic mirrors 408 and 409, and then incident on the first integrator lens array 410 which is included by the illuminance uniformizing part.

A dichroic mirror 408 is a dichroic mirror having a high reflection characteristic in the red wavelength range, and a high transmission characteristic in the green to blue wavelength ranges. On the other hand, a dichroic mirror 409 is a dichroic mirror having a high reflection characteristic in the blue wavelength range, and a high transmission characteristic in the green to red wavelength ranges.

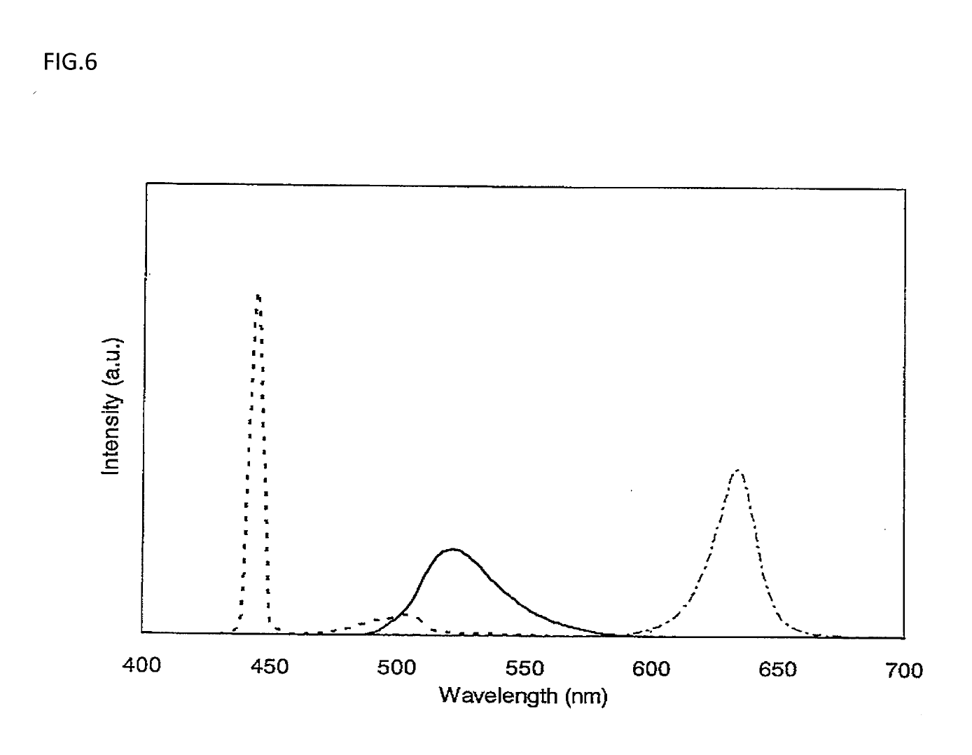

By selecting the cutoff wavelength of the dichroic mirror 414 of about 505 nm, short-wavelength components of the green LED light are reflected by the dichroic mirror. Therefore, the reflected light components can be used as the second blue light. That is, in the present embodiment, the first blue light is obtained from the excitation light source 401, which is a blue semiconductor laser; and the second blue light is obtained from short-wavelength components of the green LED light emitted by the green LED (the green light source 400), the short-wavelength components being reflected by the dichroic mirror 414 functioning as a color separation member (blue color generation part). FIG. 6 shows the spectra of light outputted from a lighting device 40 to be incident on red, blue, and green liquid-crystal-display elements, respectively.

The dominant wavelength of the unconverted excitation light, which is the first blue light, is 445 nm, and the xy-chromaticity coordinates thereof are x=0.161 and y=0.014. The dominant wavelength of the second blue light, which is composed of a part of spectral components of the green LED light, is 498 nm, and the xy-chromaticity coordinates thereof are x=0.079 and y=0.469. The xy-chromaticity coordinates of the blue output light obtained by mixing the two kinds of light are x=0.153 and y=0.058, and the blue color rendering properties have been improved. Moreover, the xy-chromaticity coordinates of the red output light are x=0.699 and y=0.301, and the xy-chromaticity coordinates of the green output light are x=0.185 and y=0.743.

### Embodiment 4

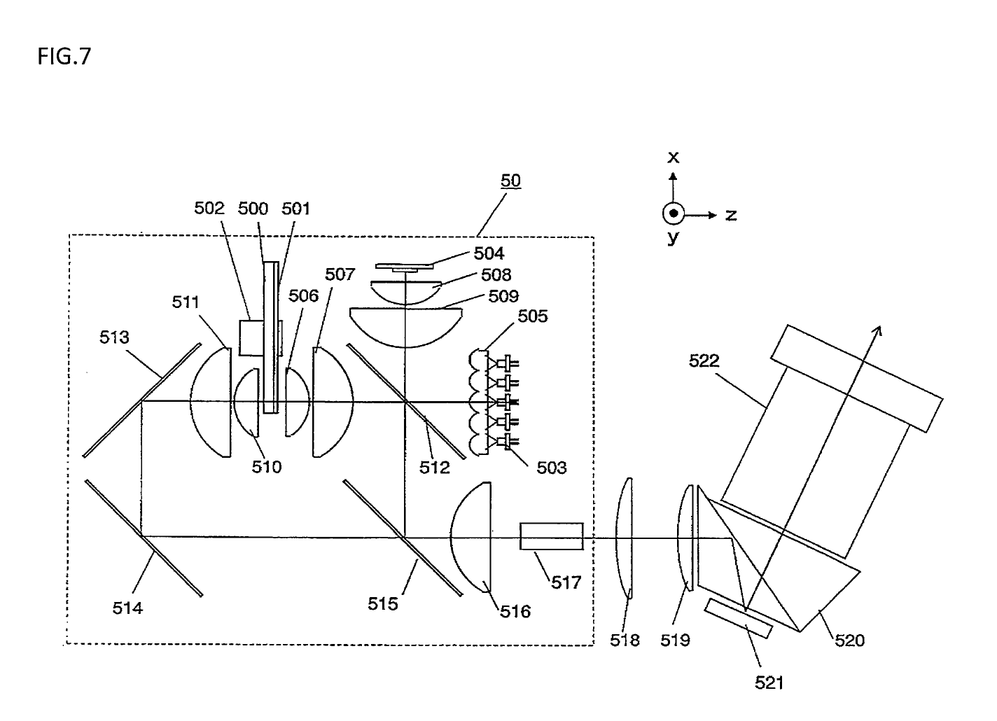

FIG. 7 shows a configuration of a light source device, and a lighting device and an image display device using the light source device according to a fourth embodiment.

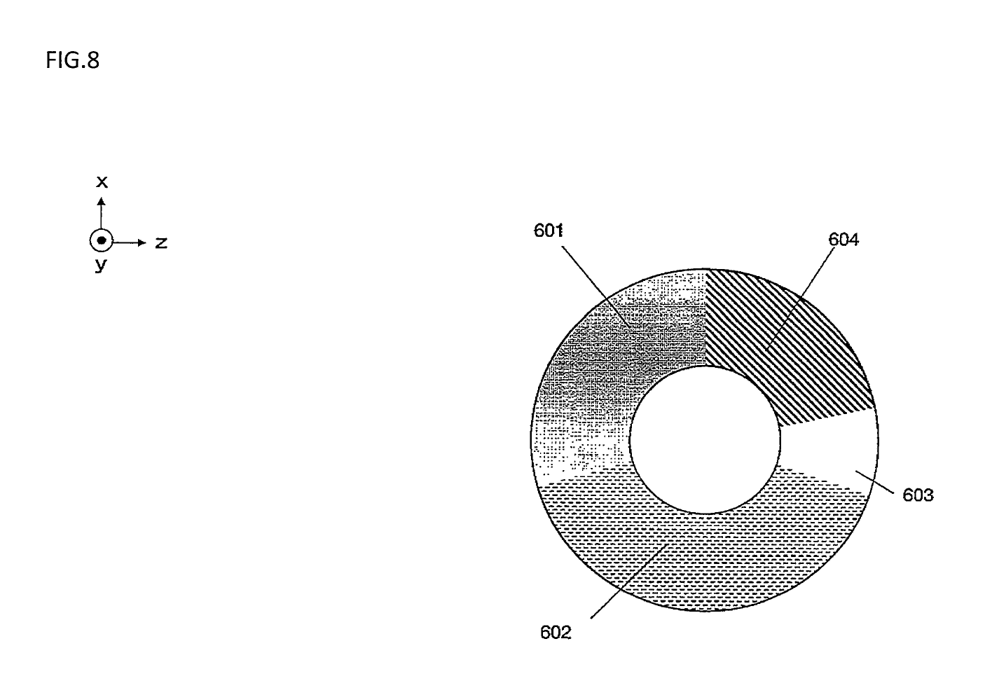

A glass base material 500 having a disc-like shape has, on the surface on one side thereof, four segment areas that are spatially divided, and a green fluorescent material 501 is applied on a thin film in two of the four segment areas. FIG. 8 schematically shows the division of the segments. A segment 601 and a segment 604 are segments on which nothing is applied, and a segment 602 and a segment 603 are segments on which the green fluorescent material is applied. A rotation part 502 is provided such that the glass base material 500 rotates about the z axis.

An excitation light source 503 is a blue semiconductor laser that oscillates around the wavelength of about 445 nm, and is a light source for the first blue light. The excitation light emitted from the excitation light source 503 is collimated by a collimator lens array 505, passes through a dichroic mirror 512, and then is condensed on the fluorescent material 501 by condenser lenses 506 and 507.

A red light source 504 is a red LED whose dominant wavelength is 623 nm, and the light emitted therefrom is collimated by collimator lenses 508 and 509.

By the rotation of the glass base material 500 being controlled, the segment that is irradiated by the excitation light is periodically changed in the order of segments 601, 602, 603, 604, and then 601 again.

For a time period in which the segment 601 is irradiated by the excitation light, the intensity of the excitation light is set to a relatively low value or becomes 0, and instead, the red light source is lit. For time periods in which the segments 602, 603, and 604 are irradiated by the excitation light, respectively, the intensity of the excitation light is set to a relatively higher value than that of the excitation light radiated on the segment 601.

A dichroic coat that allows high reflection of the excitation light and green fluorescence is applied on the surface of the glass base material 500 that corresponds to the segment 602, and the green fluorescent material 501 is application on that coat.

With respect to the segment 603, which corresponds to a time period in which the segment 603 is irradiated by the excitation light, the green fluorescent material 501 is applied on the base plate that allows high transmission of the excitation light and the green fluorescence, and moreover, on that fluorescent material, a dichroic coat is applied that allows high transmission of the excitation light and high reflection of the green fluorescent material. Accordingly, in this segment, the green fluorescence is emitted to a direction opposite to the excitation light source 503. The green fluorescence which has passed through the glass base material 500 to be emitted to the opposite side is collimated by collimator lenses 510 and 511, and then reflected by reflection mirrors 513 and 514 to be incident on a dichroic mirror 515.

The excitation light radiated on the segment 604 passes through the glass base material 500 and is incident on the dichroic mirror 515 via the collimator lenses 510 and 511, and the reflection mirrors 513 and 514, as in the case of the green fluorescence emitted from the segment 603.

The dichroic mirror 515 is a dichroic mirror whose cutoff wavelength is around 520 nm, and has a high transmission characteristic for shorter wavelengths than the cutoff wavelength, and a high reflection characteristic for longer wavelengths than the cutoff wavelength.

Therefore, dominant wavelength components of the green fluorescence emitted from the segment 602 and the red LED light are reflected by the dichroic mirror 515. On the other hand, with respect to the light that passes through the glass base material 500, the blue excitation light obtained from the segment 604 passes through the dichroic mirror 515. Moreover, a part of the green fluorescence obtained from the segment 603 passes through the dichroic mirror 515, and short-wavelength components of this green fluorescence become components of the second blue light. That is, in the present embodiment, the first blue light is obtained from the excitation light source 503, which is a blue semiconductor laser, and the second blue light is obtained from short-wavelength components, of the green fluorescence obtained from the green fluorescent material of the segment 603, which have passed through the dichroic mirror 515 functioning as a color separation member (blue color generation part).

The light spatially combined by the dichroic mirrors is condensed by a condenser lens 516 to be supplied into a rod integrator 517, which is a illuminance uniformizing part. As output light from this lighting device 50, light having illuminance uniformized by the rod integrator 517 can be obtained.

Further, light emitted from the rod integrator 517 passes through a relay lens 518, a field lens 519, and a total reflection prism 520, and then is incident on a DMD 521, which is an image display element. The relay optical system is configured such that the shape of the exit surface of the rod integrator is transferred onto the DMD 521 to allow efficient, uniform condensation of light.

The DMD 521 includes micro mirrors arranged in a two dimensional manner, and each mirror changes its inclination in accordance with a video input signal of red, green, or blue, thereby forming a signal light that is temporally modulated. In the present embodiment, the segment 601 corresponds to red signal light formation, the segment 602 corresponds to green signal light formation, and the segments 603 and 604 correspond to blue signal light formation. The signal light modulated in accordance with its corresponding input video signal is projected on the screen (not shown) by a projector lens 522 in a magnified manner.

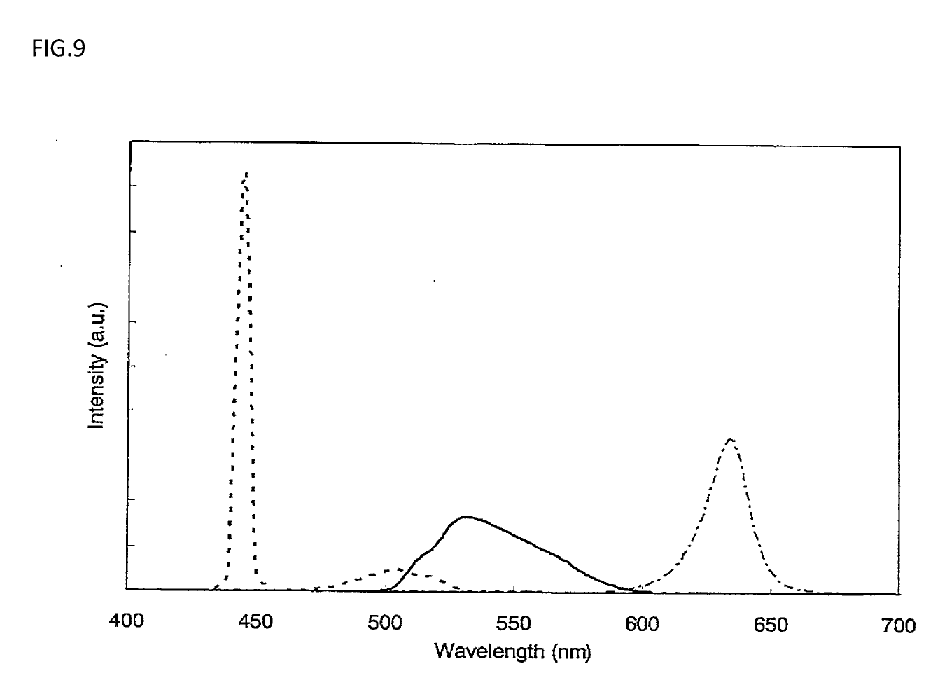

FIG. 9 shows spectra of illumination light outputted from the lighting device 50 to be incident on the DMD. The dominant wavelength of the unconverted excitation light, which is the first blue light, is 445 nm, and the xy-chromaticity coordinates thereof are x=0.161 and y=0.014. The dominant wavelength of the second blue light composed of a part of spectral components of the green LED light is 503 nm, and the xy-chromaticity coordinates thereof are x=0.072 and y=0.550.

The xy-chromaticity coordinates of the blue output light obtained by mixing the two kinds of light are x=0.153 and y=0.064, and the blue color rendering properties have been improved. The xy-chromaticity coordinates of the red output light are x=0.699 and y=0.301, and the xy-chromaticity coordinates of the green output light are x=0.280 and y=0.691.

### Embodiment 5

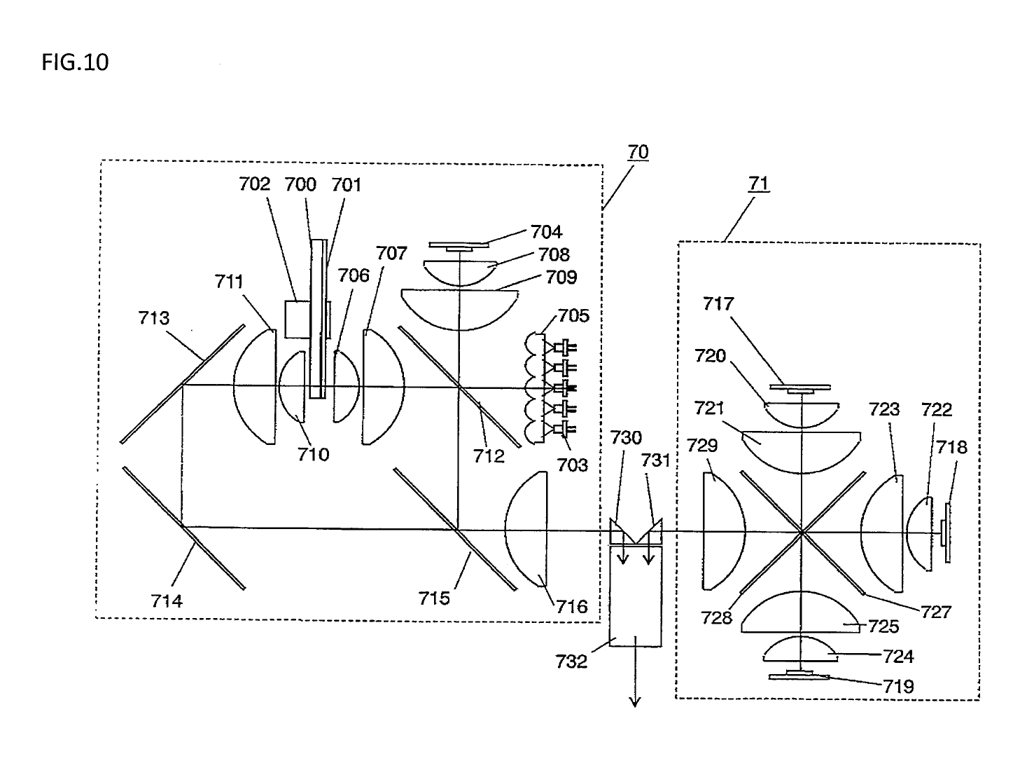

FIG. 10 shows a configuration of a light source device and a lighting device using the light source device according to a fifth embodiment. In the present embodiment, a first light source part 70 has the same configuration as the lighting device 50 in embodiment 4 up to the condenser lens 516 therein, except for the method of dividing segments on a glass base material 700, and description of the same configurations will be omitted.

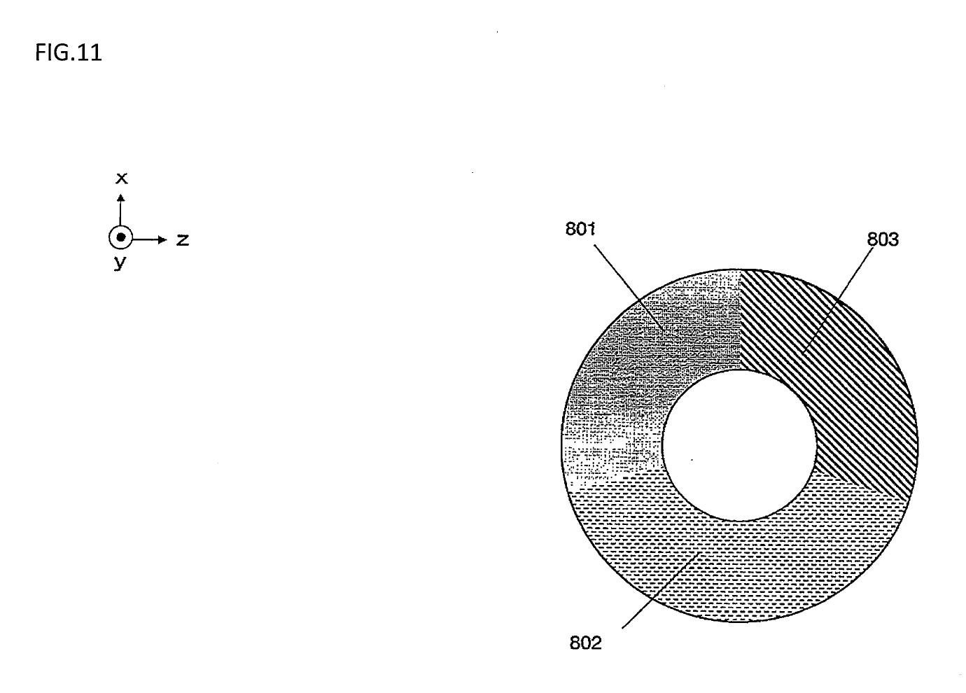

In the present embodiment, a surface of the glass base material 700 is spatially divided into three segment areas, which is shown in FIG. 11. A segment 801 and a segment 803 are segments on which nothing is applied, and have a high transmission characteristic for the wavelength of the excitation light. A segment 802 is a segment where a green fluorescent material is applied on a dichroic coat having a high reflection characteristic in the wavelength ranges of the excitation light and the green fluorescence.

Light, which has passed through a condenser lens 716, outputted from the first light source part 70 is incident on a triangular prism 730, reflected by a 45 degree inclined surface of the triangular prism 730, and then incident on a rod integrator 732.

Three color LEDs, that is, red, green, and blue, respectively, are arranged in a second light source part 71. Light from a blue light source 717, light from a green light source 718, and light from a red light source 719 are collimated by collimator lenses 720 to 725, and then are incident on dichroic mirrors 727 and 728.

The dichroic mirror 727 is a dichroic mirror that exhibits a high reflection characteristic in the red wavelength range, and a high transmission characteristic in the green and blue wavelength ranges. On the other hand, the dichroic mirror 728 is a dichroic mirror that exhibits a high reflection characteristic in the blue wavelength range, and a high transmission characteristic in the green and red wavelength ranges. Light obtained by spatially combining light from the three color LEDs, that is, red, green, and blue is incident on a triangular prism 731 by a condenser lens 729, reflected by a 45 degree inclined surface of the triangular prism 731, and then is incident on the rod integrator 732, which is an illuminance uniformizing part.

Timings at which the light sources are lit in the present embodiment will be described below.

By the rotation of the glass base material 700 being controlled, the segment on the glass base material that is irradiated by the excitation light in first light source part is periodically changed in the order of 801, 802, 803, and 801 again. For a time period in which the segment 801 is irradiated by the excitation light, the intensity of the excitation light becomes 0, and instead, a red light source 704 is lit. Further, in synchronization with this timing, the red light source 719 in the second light source part is lit.

Similarly, for a time period in which the segment 802 is irradiated by the excitation light, the green light source 718 in the second light source part is lit simultaneously. For a time period in which the segment 803 is irradiated by the excitation light, the blue light source 717 in the second light source part is lit simultaneously. In this manner, the light sources in the first light source part and the light sources in the second light source part are adjusted so as to allow simultaneous switching of the emission of light from relevant light sources.

The blue light outputted from the first light source part is semiconductor laser light whose wavelength is 445 nm, which is to be the first blue light in the above embodiments. The blue light outputted from the second light source part is LED light whose dominant wavelength is 462 nm, which is to be the second blue light. That is, in the present embodiment, the first blue light is obtained from an excitation light source 703, which is a blue semiconductor laser; and the second blue light is obtained by the blue light source 717 functioning as the blue light generation part, the blue light source 717 being a solid-state light source. These two kinds of blue light are spatially combined by the rod integrator 732, whereby the illuminance thereof is uniformized, and the resultant light is emitted as blue output light from the rod integrator.

In the present embodiment, also with respect to each of red light and green light, two kinds of light are spatially combined. With respect to the red output light, light from two red LEDs are combined by the rod integrator 732. With respect to the green output light, green fluorescence from a fluorescent material 701 and light from the green LED are similarly combined by means of the rod integrator 732. In this manner, by using a plurality of light sources for each kind of light having a color gamut, brighter illumination light can be obtained.

What is claimed is:

1. A light source device designed to emit red light, green light, and blue light,
the blue light including first blue light and second blue light,
the light source device comprising:
a red solid-state light source for emitting the red light;
a green solid-state light source for emitting the green light;
a semiconductor laser for emitting the first blue light; and
a blue light generation part for emitting the second blue light, wherein
the main component of the second blue light is light in a wavelength range of wavelengths longer than that of the first blue light.

2. The light source device according to claim 1, wherein
the blue light generation part is one of a solid-state light source and a color separation member for separating a short-wavelength component of the green light emitted from the green solid-state light source.

3. The light source device according to claim 1, wherein
a dominant wavelength of the first blue light is greater than or equal to 435 nm and less than or equal to 455 nm.

4. The light source device according to claim 1, wherein
a dominant wavelength of the second blue light is greater than or equal to 455 nm and less than or equal to 510 nm.

5. The light source device according to claim 1, wherein
the second blue light is obtained from a light emitting diode.

6. The light source device according to claim 1, wherein
the second blue light is obtained from a fluorescent material.

7. The light source device according to claim 1, wherein
the second blue light is light emitted from a fluorescent material that uses the first blue light as excitation light.

8. The light source device according to claim 1, wherein
the green light is obtained one of a light emitting diode, a fluorescent material, and a semiconductor laser.

9. The light source device according to claim 2, wherein
the color separation member is a dichroic mirror.

10. The light source device according to claim 1, wherein
a dominant wavelength of the green light is longer than a dominant wavelength of the second blue light.

11. The light source device according to claim 1, wherein
the first blue light and the second blue light are emitted at staggered timings.

12. The light source device according to claim 1, further comprising:
an illuminance uniformizing part for combining the red light, the green light, the first blue light, and the second blue light, and for uniformizing the illuminance of the resultant light.

13. The light source device according to claim 12, wherein
the illuminance uniformizing part is one of a rod integrator and a lens array.

14. The light source device according to claim 12, wherein
a dominant wavelength of combined light of the first blue light and the second blue light is greater than or equal to 455 nm and less than or equal to 475 nm.

15. A lighting device comprising the light source device according to claim 12 and a relay optical system.

16. An image display device comprising:
the light source device according to claim 12;
a relay optical system;
a spatial light modulator for displaying an image signal from without and for radiating combined light from the lighting device; and
a projection optical system for projecting on a screen images that have passed through or have been reflected from the spatial light modulator.
